(19) United States
(12) Patent Application Publication
(10) Pub. No.: US 2020/0402310 A1
(43) Pub. Date: Dec. 24, 2020

(54) VIRTUAL OBJECT DISPLAY CONTROL DEVICE, VIRTUAL OBJECT DISPLAY SYSTEM, VIRTUAL OBJECT DISPLAY CONTROL METHOD, AND STORAGE MEDIUM STORING VIRTUAL OBJECT DISPLAY CONTROL PROGRAM

(71) Applicant: MITSUBISHI ELECTRIC CORPORATION, Tokyo (JP)

(72) Inventors: Masaya NIDAIRA, Tokyo (JP); Satoshi SAKURAI, Tokyo (JP)

(73) Assignee: MITSUBISHI ELECTRIC CORPORATION, Tokyo (JP)

(21) Appl. No.: 16/971,443

(22) PCT Filed: Feb. 26, 2018
(86) PCT No.: PCT/JP2018/006957

§ 371 Date: Aug. 20, 2020

(51) Int. Cl. G06T 19/00; G06T 7/50; G06T 7/70; G06T 13/20

(52) U.S. Cl. CPC G06T 19/00; G06T 13/20; G06T 7/70; G06T 7/50

(57) ABSTRACT

A virtual object display control device includes a recognition unit to receive real space information; a viewpoint position judgment unit to judge a position of a viewpoint of an observer; a real object judgment unit to judge a position and a shape of a real object; an image control unit to generate image information for displaying an animation of a virtual object; a display setting unit to judge whether to display the animation of the virtual object or not, based on the position of the viewpoint, the position and the shape of the real object, and the image information on the virtual object and to set image information including the image information on the virtual object or the image information for displaying the animation of the virtual object as display image information based on a result of the judgment; and a drawing unit to output the display image information.

### TECHNICAL FIELD

The present invention relates to a virtual object display control device, a virtual object display control method and a virtual object display control program for performing control for displaying an image of a virtual object, and to a virtual object display system including the virtual object display control device.

### BACKGROUND ART

There has been proposed a device that displays an image of a real object and an image of a virtual object superimposed on the former image on a screen of a display device (see Patent Reference 1, for example). The image of the virtual object is an augmented reality (AR) image, for example.

### PRIOR ART REFERENCE

### Patent Reference

Patent Reference 1: Japanese Patent Application Publication No. 2015-49039

### SUMMARY OF THE INVENTION

### Problem to be Solved by the Invention

In the aforementioned conventional device, the image of the virtual object is displayed at a position shifted from a position where the image should originally be displayed, by taking into account the occlusion in the real space (i.e., so that the image of the virtual object is not hidden by the image of the real object). In this case, however, an observer cannot learn the position where the image of the virtual object should originally be displayed. Accordingly, when the image of the virtual object is an image including an annotation on a real object, it is unclear to which real object the annotation relates.

An object of the present invention is to provide a virtual object display control device, a virtual object display system, a virtual object display control method, and a virtual object display control program capable of allowing the observer to recognize the position of the image of the virtual object by means of animation display even when the image of the virtual object is displayed at a position invisible from the observer.

### Means for Solving the Problem

A virtual object display control device according to an aspect of the present invention includes a recognition unit to receive real space information indicating a real space; a viewpoint position judgment unit to judge a position of a viewpoint of an observer based on the real space information; a real object judgment unit to judge a position and a shape of a real object based on the real space information; an image control unit to receive image information on a virtual object and to process the image information on the virtual object, thereby generating image information for displaying an animation of the virtual object; a display setting unit to judge whether to display the animation of the virtual object or not, based on the position of the viewpoint, the position and the shape of the real object, and the image information on the virtual object, and to set image information including any one of the image information on the virtual object and the image information for displaying the animation of the virtual object, as display image information, based on a result of the judgment; and a drawing unit to output the display image information.

A virtual object display system according to another aspect of the present invention includes a space information acquisition unit to acquire real space information indicating a real space; a recognition unit to receive the real space information; a viewpoint position judgment unit to judge a position of a viewpoint of an observer based on the real space information; a real object judgment unit to judge a position and a shape of a real object based on the real space information; an image control unit to receive image information on a virtual object and to process the image information on the virtual object, thereby generating image information for displaying an animation of the virtual object; a display setting unit to judge whether to display the animation of the virtual object or not, based on the position of the viewpoint, the position and the shape of the real object, and the image information on the virtual object and to set image information including any one of the image information on the virtual object and the image information for displaying the animation of the virtual object, as display image information based on a result of the judgment; a drawing unit to output the display image information; and a display device to display an image based on the display image information.

### Effect of the Invention

According to the present invention, even when the image of the virtual object is displayed at a position invisible from the observer, it is possible to allow the observer to recognize the position of the image of the virtual object by means of animation display.

### BRIEF DESCRIPTION OF THE DRAWINGS

FIG. 1 is a diagram showing a hardware configuration of a virtual object display system according to a first embodiment of the present invention.

FIG. 2 is a diagram schematically showing a positional relationship between a position of a viewpoint and a real object (occluding object).

FIG. 3 is a functional block diagram showing a virtual object display control device according to the first embodiment.

FIG. 4 is an explanatory diagram showing the virtual object display system according to the first embodiment.

FIG. 5 is a diagram showing an example of a display image of a virtual object displayed by animation (at a time of normal size) on a display device of the virtual object display system according to the first embodiment.

FIG. 6 is a diagram showing an example of the display image of the virtual object displayed by animation (at a time of enlarged size) on the display device of the virtual object display system according to the first embodiment.

FIG. 7 is a diagram showing an example of the display image of the virtual object displayed by animation (namely, moving display) on the display device of the virtual object display system according to the first embodiment.

FIG. 8 is a flowchart showing the operation of the virtual object display control device according to the first embodiment.

FIG. 9 is a diagram showing a hardware configuration of a virtual object display system according to a second embodiment of the present invention.

FIG. 10 is an explanatory diagram showing the virtual object display system according to the second embodiment.

FIG. 11 is a diagram showing a hardware configuration of a virtual object display system according to a third embodiment of the present invention.

FIG. 12 is an explanatory diagram showing the virtual object display system according to the third embodiment.

### MODE FOR CARRYING OUT THE INVENTION

Virtual object display control devices, virtual object display systems, virtual object display control methods and virtual object display control programs according to embodiments of the present invention will be described below with reference to the accompanying drawings. The following embodiments are just examples and a variety of modifications are possible within the scope of the present invention.

Incidentally, an xyz orthogonal coordinate system is shown in the drawings. In the xyz orthogonal coordinate system, the x-axis represents a transverse direction (i.e., horizontal transverse direction) in the real space, the y-axis represents a depth direction (i.e., horizontal depth direction) in the real space, and the z-axis represents a height direction (i.e., vertical direction) in the real space.

### First Embodiment

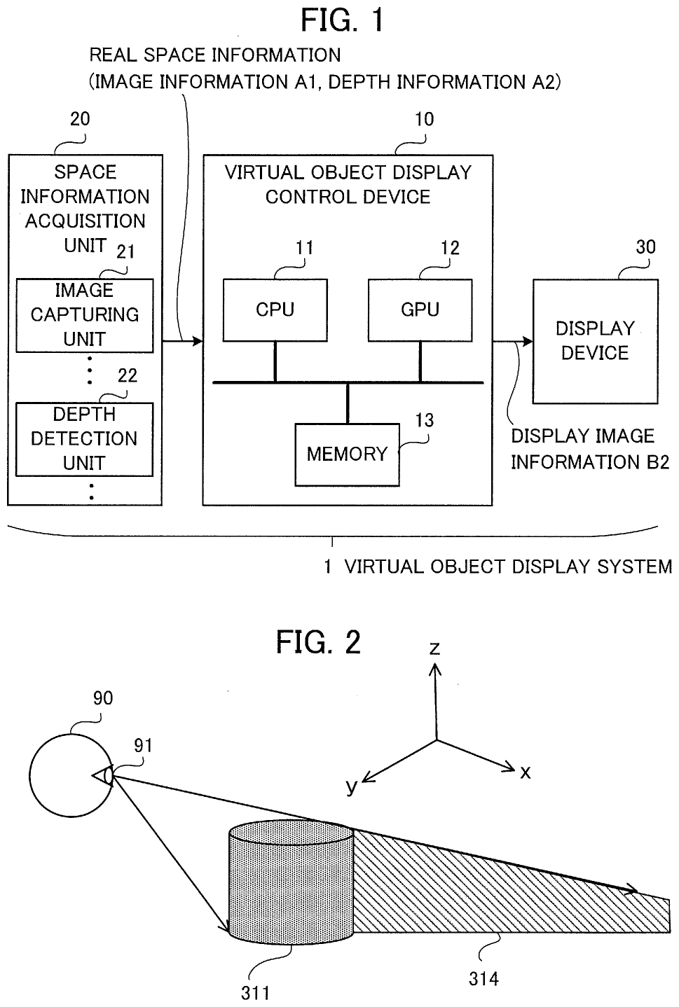

First, a configuration of a virtual object display system 1 and a virtual object display control device 10 will be described below. FIG. 1 is a diagram showing a hardware configuration of the virtual object display system 1 according to a first embodiment. As shown in FIG. 1, the virtual object display system 1 includes a space information acquisition unit 20 as a space detection unit that acquires real space information indicating a real space (i.e., real world), a display device 30 that displays an image, and the virtual object display control device 10 that makes the display device 30 display the image. The display device 30 displays an image of a real object and an image of a virtual object, for example. The image of the virtual object is an AR image, for example. The virtual object display control device 10 is a device capable of executing a virtual object display control method according to the first embodiment.

The space information acquisition unit 20 includes, for example, one or more image capturing units 21 for acquiring image information A1 on the real space and one or more depth detection units 22 for acquiring depth information A2 on a real object (i.e., object) existing in the real space. The space information acquisition unit 20 may be configured to include one of the image capturing unit 21 and the depth detection unit 22. The image capturing unit 21 is, for example, a color camera (referred to also as an “RGB camera”) that acquires a color image, a stereo camera that simultaneously captures images of a real object from a plurality of different directions, or the like. The depth detection unit 22 is, for example, a depth camera (referred to also as a “camera with a depth sensor”) having a function of detecting the depth (deepness) of a real object, or the like. In the first embodiment, the real space information includes the image information A1 on the real space and the depth information A2 on the real object.

The virtual object display control device 10 includes a CPU (Central Processing Unit) 11 as an information processing unit, a GPU (Graphics Processing Unit) 12 as an image processing unit, and a memory 13 as a storage unit for storing information. The GPU 12 is a graphics drawing unit and writes image data as a result of drawing to the memory 13 (i.e., performs the drawing) based on a drawing command received from the CPU 11. The image data written to the memory 13 is transferred to the display device 30. Functions of the GPU 12 may be executed by the CPU 11. The virtual object display control device 10 is, for example, a personal computer (PC), a smartphone, a tablet terminal, or the like. The memory 13 may store a virtual object display control program according to the first embodiment. The CPU 11 is capable of controlling a display operation of the display device 30 by executing the virtual object display control program.

The display device 30 is, for example, a device having a display screen (i.e., display), such as a PC monitor, a smartphone or a tablet terminal.

FIG. 2 is a diagram schematically showing a positional relationship between a position 91 of a viewpoint of an observer 90 and a real object 311. The real object 311 can exist as an occluding object that hides a virtual object. When the real object 311 exists in the real space, the observer 90 cannot view an image of the virtual object displayed in a region (hatched region) 314 hidden by the real object 311 from the position 91 of the viewpoint. Further, when the image of the virtual object is moved to a different position, it becomes unclear to which real object the image of the virtual object is related. Therefore, the virtual object display control device 10 judges the position 91 of the viewpoint of the observer 90 and the position and the shape of the real object 311 based on the real space information, and judges whether animation display as moving display is necessary or not, based on the position 91 of the viewpoint, the position and the shape of the real object 311, and image information on the virtual object. The animation display is, for example, scaling display of the image of the virtual object, reciprocating movement of the image of the virtual object, or the like. When the animation display is necessary, the virtual object display control device 10 sets image information on the animation display and outputs image information for displaying the animation of the virtual object (i.e., animation image information). When the animation display is unnecessary, the virtual object display control device 10 outputs image information for displaying the virtual object in a normal size as a still image (i.e., normal image information).

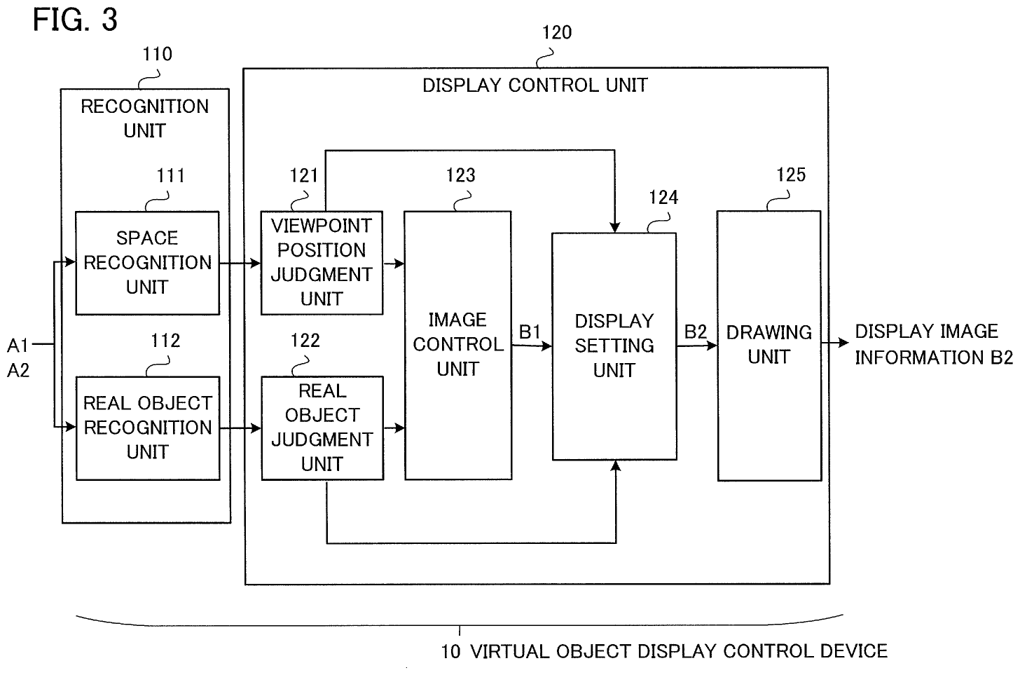

FIG. 3 is a functional block diagram showing the virtual object display control device 10 according to the first embodiment. As shown in FIG. 3, the virtual object display control device 10 includes a recognition unit 110 that receives the image information A1 on the real space and the depth information A2 on the real object as the real space information and a display control unit 120.

The recognition unit 110 includes, for example, a space recognition unit 111 that receives the image information A1 on the real space (i.e., object space), performs a recognition process for recognizing at which position in the real space the real object exists, and supplies the result of the process to the display control unit 120 and a real object recognition unit 112 that receives the depth information A2 on the real object, performs a recognition process for recognizing what the real object is, and supplies the result of the process to the display control unit 120. The real object recognition unit 112 may output data in which the real object has been replaced with a model of the real object (i.e., previously stored image information). The model of the real object, as previously stored image information, may be image information on a desk, a chair or the like, or a typical three-dimensional shape such as a cylinder, a rectangular prism, a triangular pyramid or a sphere. However, the configuration and the functions of the recognition unit 110 are not limited to the above-described examples.

The display control unit 120 includes a viewpoint position judgment unit 121 that judges the position 91 of the viewpoint of the observer 90 based on the real space information supplied from the recognition unit 110 and a real object judgment unit 122 that judges the position and the shape of the real object 311 based on the real space information supplied from the recognition unit 110. The viewpoint position judgment unit 121 calculates the position 91 of the viewpoint of the observer 90 observing the virtual object displayed in the real space based on position information received from the space recognition unit 111 and generates viewpoint position information indicating the position of the viewpoint. The real object judgment unit 122 is an occluding object judgment unit that calculates the position of an occluding object hiding the virtual object displayed in the real space based on real object information received from the real object recognition unit 112 and generates occluding object judgment information indicating the occluding object.

Further, the display control unit 120 includes an image control unit 123 that receives the image information on the virtual object and generates the image information for displaying the animation of the virtual object by processing the image information on the virtual object. The image information on the virtual object is comment information on the real object 311, for example. The image control unit 123 may either previously store the image information on the virtual object or acquire the image information on the virtual object from an external storage device (not shown) or the memory 13 (FIG. 1). The image control unit 123 supplies the image information on the virtual object and the image information for displaying the animation of the virtual object to a display setting unit 124. The animation display is a display method of repeatedly switching the image of the virtual object to an enlarged size and a normal size (i.e., scaling display), for example. Alternatively, the animation display may be a display method of repeatedly moving (reciprocating) the image of the virtual object between an original image position of the virtual object and a position not hidden by the real object (i.e., moving display), for example. The image information supplied from the image control unit 123 to the display setting unit 124 will be referred to as image information B1.

The image control unit 123 may select the scaling display or the moving display as the method of displaying the animation of the virtual object according to a condition. For example, the image control unit 123 employs the scaling display as the animation display when the virtual object exists at a position at a distance greater than a predetermined reference distance from the observer 90, and employs the moving display as the animation display when the virtual object exists within the reference distance. Alternatively, the image control unit 123 may select the moving display as the animation display when the virtual object is a comment including letters, and select the scaling display as the animation display when the virtual object is not a comment. Further, the image control unit 123 may select the moving display as the animation display when the real object occluding the virtual object is larger than a predetermined reference size, and select the scaling display as the animation display when the real object occluding the virtual object is smaller than or equal to the reference size. The animation display selection method is not limited to these examples.

The display control unit 120 includes the display setting unit 124 that judges whether to display the image of the animation of the virtual object or not, based on the position 91 of the viewpoint, the position and the shape of the real object 311, and the image information B1 and sets image information including the image information on the virtual object or the image information for displaying the animation of the virtual object as display image information B2 based on the result of the judgment, and a drawing unit 125 that outputs the display image information B2 to the display device 30 by writing the display image information B2 to the memory 13.

The display setting unit 124 may set the image information for displaying the animation of the virtual object as the display image information B2 when the whole or part of the virtual object is hidden by the real object as viewed from the position of the viewpoint. The display setting unit 124 may judge that the animation display of the virtual object is necessary when a predetermined certain proportion or more (e.g., 50% or more) of the virtual object is hidden by the real object as viewed from the position 91 of the viewpoint.

It is also possible for the display setting unit 124 to set synthetic image information obtained by combining the image information on the virtual object or the image information for displaying the animation of the virtual object with the image information A1 on the real space, as the display image information B2.

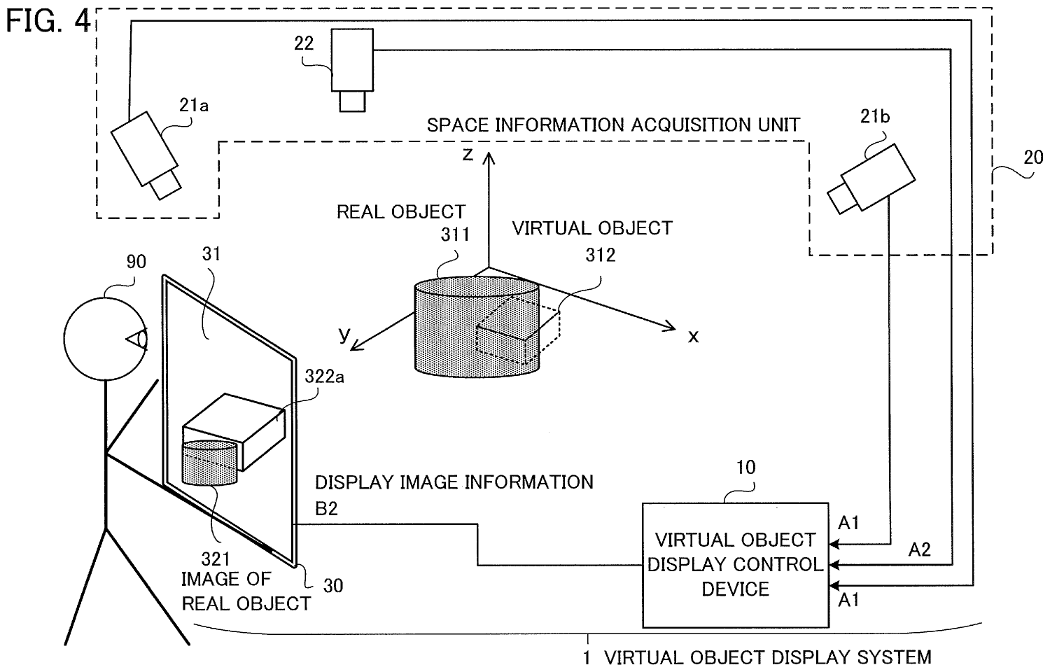

Next, the operation of the virtual object display control device 10 will be described below. FIG. 4 is an explanatory diagram showing the virtual object display system 1. In FIG. 4, two image capturing units 21a and 21b are shown as the image capturing unit 21 in FIG. 1. In the example of FIG. 4, the image capturing units 21a and 21b of the space information acquisition unit 20 supply the image information A1 on the real space to the virtual object display control device 10, and the depth detection unit 22 supplies the depth information A2 on the real object to the virtual object display control device 10.

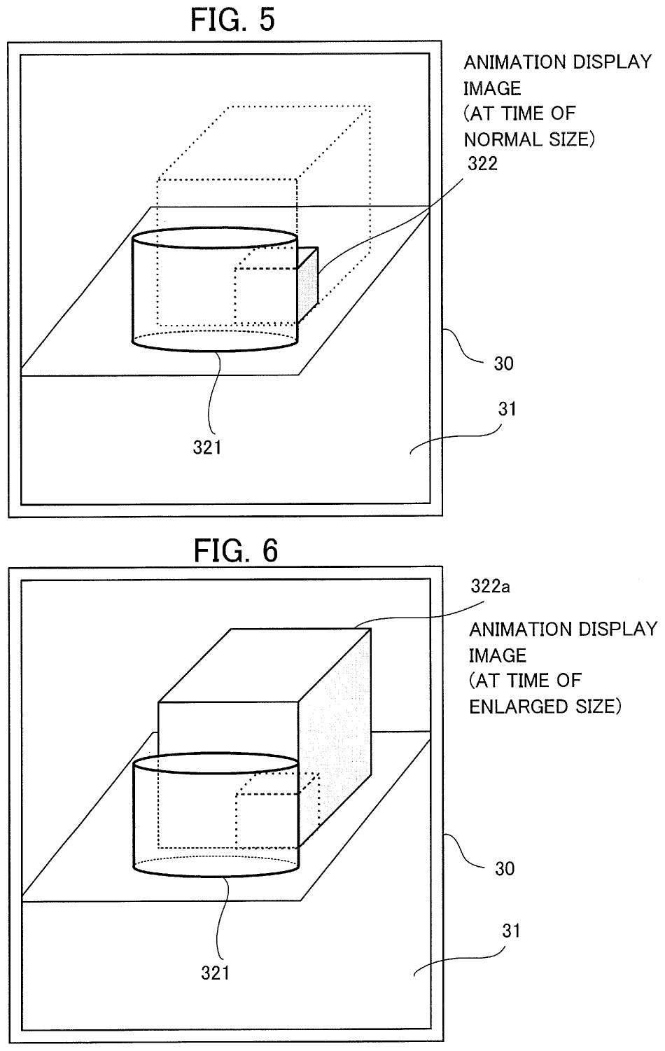

FIG. 5 and FIG. 6 are diagrams showing an example of an animation display image 322 of the virtual object on the display device 30 of the virtual object display system 1 according to the first embodiment. FIG. 5 and FIG. 6 show a case where the animation display is the scaling display. FIG. 5 shows a case where the animation display image 322 is in the normal size, and FIG. 6 shows a case where the animation display image 322 is in the enlarged size. The magnification factor at the time of enlargement is at a value with which the image of the virtual object has a part not occluded by the image of the real object. At the time of enlargement, the scaling display may be combined with emphasis display such as increasing the luminance or changing the color.

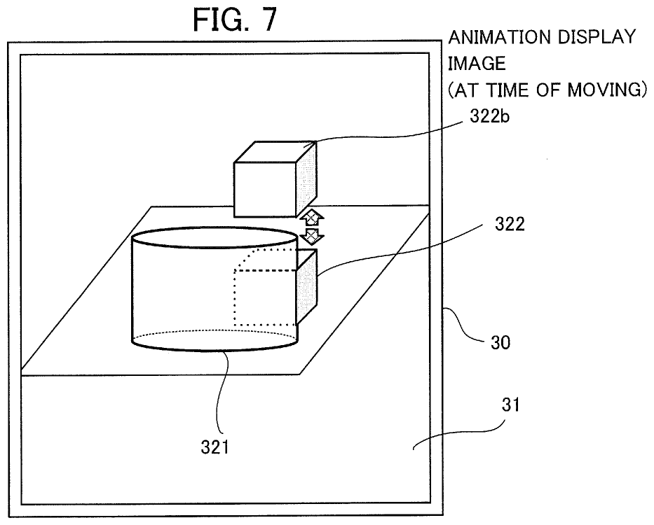

FIG. 7 is a diagram showing an example of an animation display image on the display device 30 of the virtual object display system 1 according to the first embodiment. FIG. 7 shows a case where the animation display of a virtual object is a moving display. In FIG. 7, an image 322a of the virtual object at a time of movement is shown above an image 322 of the virtual object situated at its original position. However, the position of the image 322a of the virtual object at the time of movement may also be a position laterally moved from the original position or a position moved in an oblique direction from the original position. Further, the position of the image 322a of the virtual object at the time of movement may be a position where the image of the virtual object is not occluded by the image of the real object and the moving distance is the shortest. At the time of movement, the moving display may be combined with the emphasis display such as increasing the luminance or changing the color.

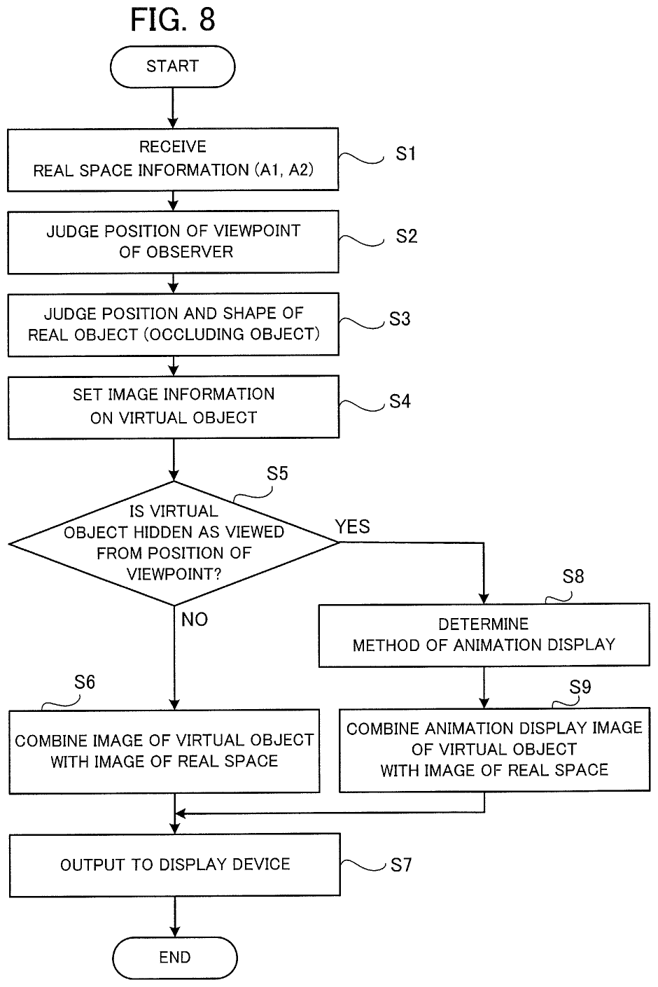

FIG. 8 is a flowchart showing the operation of the virtual object display control device 10. The virtual object display control device 10 receives the real space information in step S1, judges the position 91 of the viewpoint of the observer 90 based on the real space information (e.g., the image information A1 on the real space) in step S2, judges the position and the shape of the real object 311 based on the real space information (e.g., the depth information A2 on the real object) in step S3, and sets the image information on the virtual object 312 based on the position 91 of the viewpoint and the position and the shape of the real object 311 (or the position and the shape of the modelized real object) in step S4.

Subsequently, the virtual object display control device 10 in step S5 judges whether to display the animation of the virtual object or not, based on the position 91 of the viewpoint, the position and the shape of the real object 311, and the image information on the virtual object. In other words, the virtual object display control device 10 judges whether or not the image 322 of the virtual object 312 is hidden by the image 321 of the real object 311 as viewed from the position 91 of the viewpoint.

When the image 322 of the virtual object 312 is not hidden (NO in the step S5), the virtual object display control device 10 in step S6 draws the image 321 of the real object based on the image information on the real space and draws the image 322 of the virtual object. Then, the virtual object display control device 10 in step S7 makes the display device 30 display the image 321 of the real object and the image 322 of the virtual object.

When the image 322 of the virtual object 312 is hidden (YES in the step S5), the virtual object display control device 10 determines the method of the animation display in step S8, and draws the image 321 of the real object based on the image information on the real space and draws the image 321 of the virtual object and the animation display image 322 of the virtual object in step S9. Then, as shown in FIG. 5 and FIG. 6, the virtual object display control device 10 makes the display device 30 display the image 321 of the real object and the animation display image 322 of the virtual object.

As described above, with the virtual object display system 1 and the virtual object display control device 10 according to the first embodiment, even when the image of the virtual object is displayed at a position invisible from the observer 90 such as behind the real object, the image of the virtual object is displayed to be visible from the observer 90 by means of the animation display image 322 of the virtual object, and thus it is possible to allow the observer 90 to recognize the position of the image 322 of the virtual object.

Further, with the virtual object display system 1 and the virtual object display control device 10 according to the first embodiment, the animation display image 322 is displayed at the original position of the virtual object, and thus the observer 90 can correctly recognize about which real object the animation display image 322 of the virtual object is.

### Second Embodiment

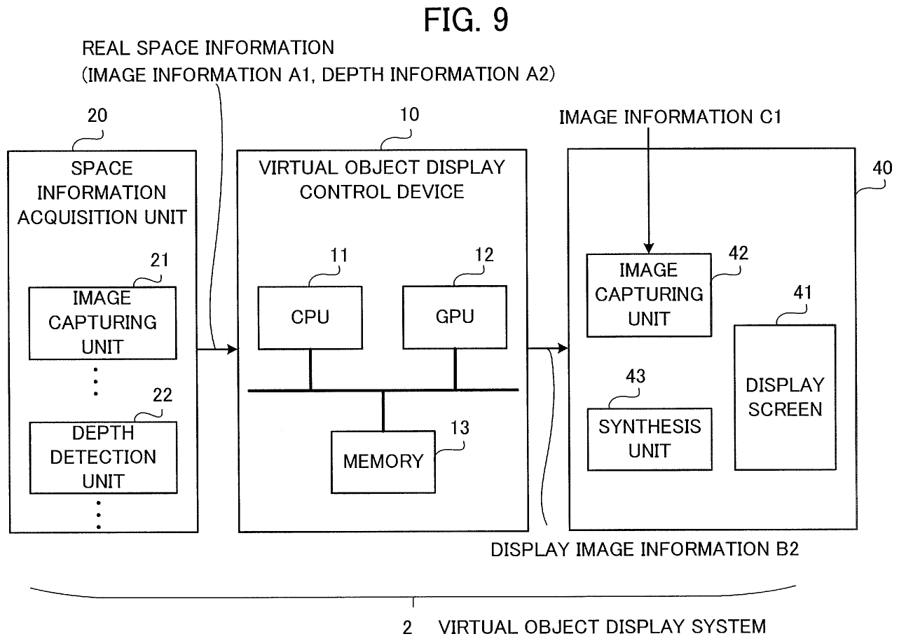

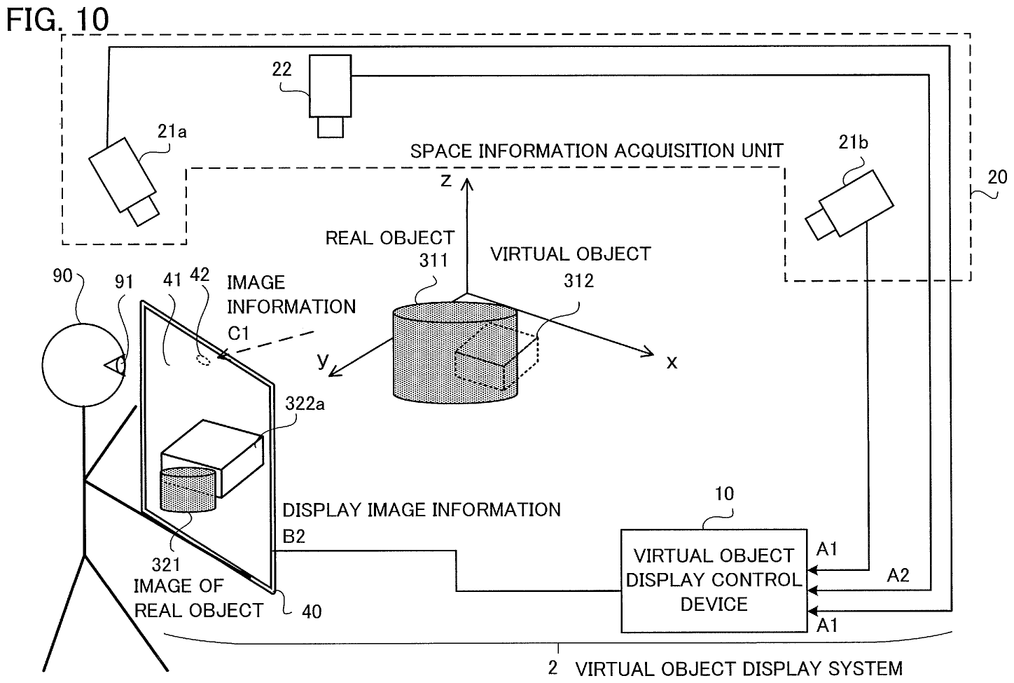

FIG. 9 is a diagram showing a hardware configuration of a virtual object display system 2 according to a second embodiment. In FIG. 9, each component identical or corresponding to a component shown in FIG. 1 is assigned the same reference character as in FIG. 1. FIG. 10 is an explanatory diagram showing the virtual object display system 2 of FIG. 9. In FIG. 10, each component identical or corresponding to a component shown in FIG. 4 is assigned the same reference character as in FIG. 4.

The virtual object display system 2 shown in FIG. 9 and FIG. 10 differs from the virtual object display system 1 shown in FIG. 1 in that a display device 40 includes an image capturing unit 42 that acquires image capture information C1 as viewed from the position 91 of the viewpoint, a display screen 41, and a synthesis unit 43 that makes the display screen 41 display an image in which the image information B1 on the virtual object and display image information B2 on guidance are superimposed on the image capture information C1.

In the virtual object display system 2, the virtual object display control device 10 may receive the position 91 of the viewpoint of the observer 90 from the display device 40.

Further, in the virtual object display system 2, the image capturing unit 42 of the display device 40 may be used as the image capturing unit of the space information acquisition unit 20.

As described above, with the virtual object display system 2 and the virtual object display control device 10 according to the second embodiment, even when the display image of the virtual object is displayed at a position invisible from the observer 90, it is possible to allow the observer 90 to recognize the virtual object by means of the animation display image of the virtual object.

Except for the above-described features, the virtual object display system 2 shown in FIG. 9 and FIG. 10 is the same as the virtual object display system 1 shown in FIG. 1 and FIG. 4.

### Third Embodiment

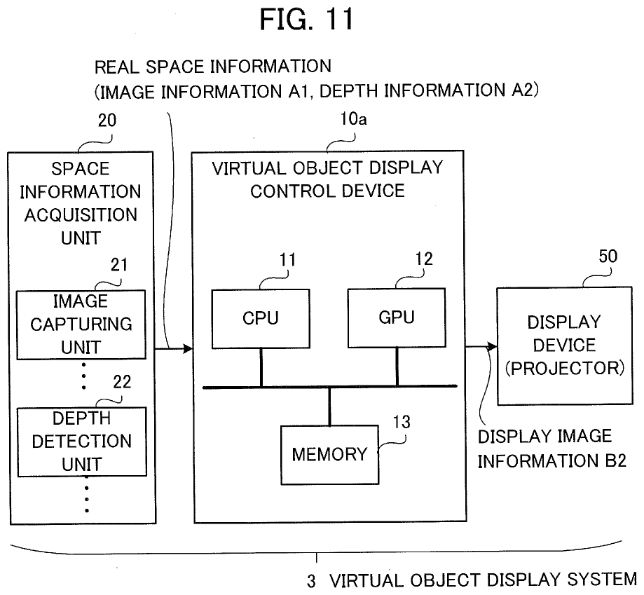

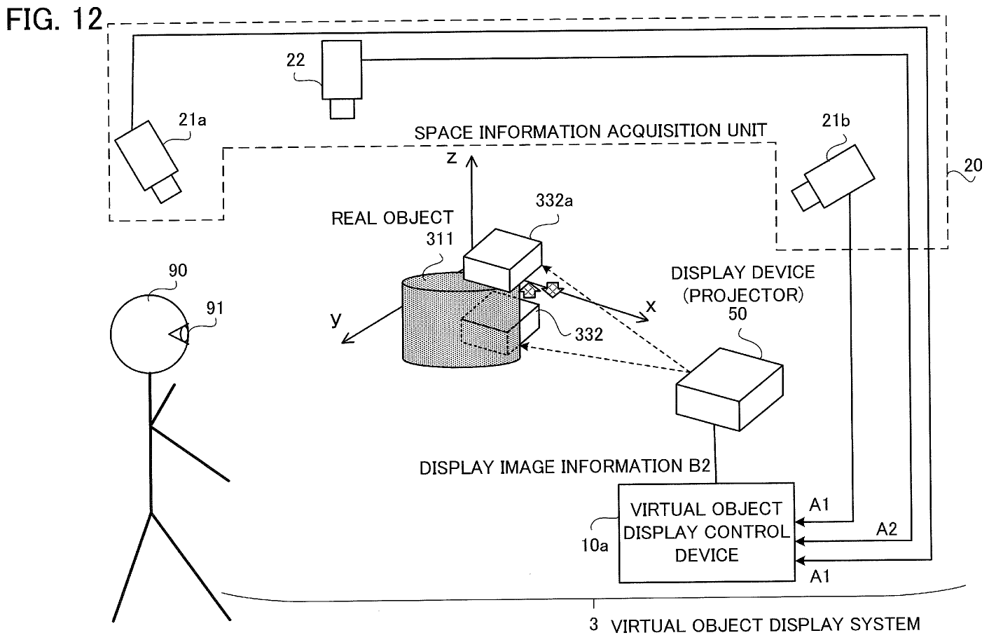

FIG. 11 is a diagram showing a hardware configuration of a virtual object display system 3 according to a third embodiment. In FIG. 11, each component identical or corresponding to a component shown in FIG. 1 is assigned the same reference character as in FIG. 1. FIG. 12 is an explanatory diagram showing the virtual object display system 3 of FIG. 11. In FIG. 12, each component identical or corresponding to a component shown in FIG. 4 is assigned the same reference character as in FIG. 4.

The virtual object display system 3 shown in FIG. 11 and FIG. 12 differs from the virtual object display system 1 shown in FIG. 1 and FIG. 4 in that a display device 50 is a projector that projects an image onto the real space (i.e., real world) and animation display images 332 and 332a of the virtual object are projection images displayed on a floor, a wall, a ceiling, a real object or the like in the real space. In the example of FIG. 12, the animation display images 332 and 332a of the virtual object are animation images repeatedly switched between the position where the virtual object should originally be displayed and a position directly above the former position.

As described above, with the virtual object display system 3 and a virtual object display control device 10a according to the third embodiment, even when the display image 332 of the virtual object is displayed at a position invisible from the observer 90, it is possible to allow the observer 90 to recognize the virtual object by means of the animation display images 332 and 332a of the virtual object.

Further, with the virtual object display system 3 and the virtual object display control device 10a according to the third embodiment, the position of the animation display image 332, 332a of the virtual object is moved repeatedly, and thus the observer 90 can correctly recognize about which real object the animation display images 332 and 332a of the virtual object are.

Furthermore, the intention of guidance becomes easier to understand since a guidance display 333 is directly projected onto the real world and the space information on the real world is usable without change.

Except for the above-described features, the virtual object display system 3 shown in FIG. 11 and FIG. 12 is the same as the virtual object display system 1 shown in FIG. 1 and FIG. 4 or the virtual object display system 2 shown in FIG. 9 and FIG. 10.

### DESCRIPTION OF REFERENCE CHARACTERS

1, 2, 3: virtual object display system, 10, 10a: virtual object display control device, 20: space information acquisition unit, 21, 21a, 21b: image capturing unit, 22: depth detection unit, 30, 40: display device, 31, 41: display screen, 42: image capturing unit, 43: synthesis unit, 50: display device (projector), 90: observer, 91: position of viewpoint, 110: recognition unit, 120: display control unit, 121: viewpoint position judgment unit, 122: real object judgment unit, 123: image control unit, 124: display setting unit, 125: drawing unit, 311: real object, 312: virtual object, 321: image of real object, 322: animation display image (at time of normal size), 322a: animation display image (at time of enlarged size), 322b: animation display image (at time of movement), 332: animation display image, 332a: animation display image (at time of movement), A1: image information on real space, A2: depth information on real object, B2: display image information.

1. A virtual object display control device comprising:
a processor to execute a program; and
a memory to store the program which, when executed by the processor, performs the processes of:
receiving real space information indicating a real space;
judging a position of a viewpoint of an observer based on the real space information;
judging a position and a shape of a real object based on the real space information;
receiving image information on a virtual object and processing the image information on the virtual object, thereby generating image information for displaying an animation of the virtual object;
judging whether to display the animation of the virtual object or not, based on the position of the viewpoint, the position and the shape of the real object, and the image information on the virtual object, and setting image information including any one of the image information on the virtual object and the image information for displaying the animation of the virtual object, as display image information, based on a result of the judgment; and
outputting the display image information,
wherein the image information for displaying the animation of the virtual object is set as the display image information when a whole or part of the virtual object is hidden by the real object as viewed from the position of the viewpoint.

2. (canceled)

3. The virtual object display control device according to claim 1, wherein the image information for displaying the animation of the virtual object is image information for scaling display as display performed so that size of the virtual object changes or image information for moving display as display performed so that the virtual object moves.

4. The virtual object display control device according to claim 1, wherein the image information for displaying the animation of the virtual object is image information for scaling display as display performed so that size of the virtual object changes and image information for moving display as display performed so that the virtual object moves, and any one of the image information for the scaling display and the image information for the moving display is selected based on a predetermined condition.

5. The virtual object display control device according to claim 1, wherein the real space information includes image information on the real space and depth information on the real object.

6. The virtual object display control device according to claim 1, wherein synthetic image information obtained by combining the image information on the virtual object or the image information for displaying the animation of the virtual object with image information on the real space is outputted as the display image information.

7. A virtual object display system comprising:
a camera to acquire real space information indicating a real space;
the virtual object display control device according to claim 1; and
a display device to display an image based on the display image information.

8. The virtual object display system according to claim 7, wherein the camera acquires image information on the real space and depth information on the real object.

9. The virtual object display system according to claim 7, wherein synthetic image information obtained by combining image information outputted from the image control unit with image information on the real space is set as the display image information.

10. The virtual object display system according to claim 7, wherein the display device includes:
another camera to acquire image capture information as viewed from the position of the viewpoint; and
a display screen;
wherein the display device makes the display screen display an image in which image information for displaying an animation of the virtual object is superimposed on the image capture information.

11. The virtual object display system according to claim 7, wherein the display device includes a projector to project the display image information onto the real space.

12. A virtual object display control method comprising:
receiving real space information indicating a real space;
judging a position of a viewpoint of an observer based on the real space information;
judging a position and a shape of a real object based on the real space information;
receiving image information on a virtual object and processing the image information on the virtual object, thereby generating image information for displaying an animation of the virtual object;
judging whether to display the animation of the virtual object or not, based on the position of the viewpoint, the position and the shape of the real object, and the image information on the virtual object, and setting image information including any one of the image information on the virtual object and the image information for displaying the animation of the virtual object, as display image information based on a result of the judgment; and
outputting the display image information,
wherein, at the setting of the image information, the image information for displaying the animation of the virtual object is set as the display image information when a whole or part of the virtual object is hidden by the real object as viewed from the position of the viewpoint.

13. A non-transitory computer-readable storage medium storing a virtual object display control program that causes a computer to execute processing comprising:
receiving real space information indicating a real space;
judging a position of a viewpoint of an observer based on the real space information;
judging a position and a shape of a real object based on the real space information;
receiving image information on a virtual object and processing the image information on the virtual object, thereby generating image information for displaying an animation of the virtual object;
judging whether to display the animation of the virtual object or not, based on the position of the viewpoint, the position and the shape of the real object, and the image information on the virtual object, and setting image information including any one of the image information on the virtual object and the image information for displaying the animation of the virtual object, as display image information based on a result of the judgment; and
outputting the display image information,
wherein, at the setting of the image information, the image information for displaying the animation of the virtual object is set as the display image information when a whole or part of the virtual object is hidden by the real object as viewed from the position of the viewpoint.
